(19) United States
(12) Patent Application Publication
(10) Pub. No.: US 2010/0328322 A1
(43) Pub. Date: Dec. 30, 2010

(54) IMAGE PROCESSING APPARATUS

(75) Inventors: Tomonori YONEMOTO, Yokohama-shi (JP); Keisuke Nakazono, Hino-shi (JP); Akira Ueno, Hachioji-shi (JP); Ryosuke Mochizuki, Hino-shi (JP)

Correspondence Address: Frishauf, Holtz Goodman & Chick, P.C., 16th Floor, 220 Fifth Avenue, New York, NY, 10001-7708, US

(73) Assignee: Olympus Corporation, Tokyo (JP)

(21) Appl. No.: 12/821,503

(22) Filed: Jun. 23, 2010

(30) Foreign Application Priority Data
Jun. 24, 2009 (JP) 2009-150004
Jun. 16, 2010 (JP) 2010-137745

(51) Int. Cl. G06T 1/00

(52) U.S. Cl. 345/501

(57) ABSTRACT

An image processing apparatus includes an image processing block, a plurality of control blocks, and a plurality of register sets. The image processing block carries out a specific process based on input setting data. Each of the plurality of control blocks controls the specific process of the image processing block independently. The plurality of register sets are used in data communication between each of the plurality of control blocks and the image processing block. When any one of the plurality of control blocks is controlling the specific process of the image processing block, each of the remaining control blocks performs data communication with the image processing block using the corresponding register set.

### CROSS-REFERENCE TO RELATED APPLICATIONS

This application is based upon and claims the benefit of priority from prior Japanese Patent Applications No. 2009-150004, filed Jun. 24, 2009; and No. 2010-13774, filed Jun. 16, 2010, the entire contents of both of which are incorporated herein by reference.

### BACKGROUND OF THE INVENTION

1. Field of the Invention

This invention relates to the technique for shortening the processing time of an image processing apparatus.

2. Description of the Related Art

An image processing apparatus which divides one frame of image data into a plurality of blocks, inputs divided blocks of image data via a lower-capacity memory to a plurality of image processing blocks connected in series, and processes the divided blocks has been disclosed in, for example, Jpn. Pat. Appln. KOKAI Publication No. 2000-312327. With the configuration of Jpn. Pat. Appln. KOKAI Publication No. 2000-312327, image data can be read from a frame memory, such as an SDRAM, once and written into the frame memory once, thereby processing a plurality of images.

In the configuration of Jpn. Pat, Appln. KOKAI Publication. No. 2000-312327, a process completion interrupt signal is issued to the CPU acting as a control block each time the processing of a block is completed. With such a configuration, since the CPU must process the next block each time an interrupt signal is issued, the load on the CPU is liable to increase. Therefore, in Jpn. Pat. Appln. KOKAI Publication No. 2005-78608, a sequencer, another control block differing from the CPU, is used as means for decreasing the load on the CPU. In Jpn. Pat. Appln. KOKAI Publication No. 2005-78608, the sequencer can control the processing of a halfway block in one frame to decrease the load on the CPU.

Furthermore, Jpn. Pat. Appln. KOKAI Publication No. 2005-44098 has disclosed a configuration (or a distortion correction range computing unit) which calculates an input image range where distortion correction is to be made from an output image range when a distortion correction process is carried out as image processing. In Jpn. Pat. Appln. KOKAI Publication No. 2005-44098, when a sequencer controls the distortion correction block, the sequencer has to control the distortion correction range computing unit for each of a plurality of blocks into which one frame has been divided.

### BRIEF SUMMARY OF THE INVENTION

According to a first aspect of the invention, there is provided an image processing apparatus comprising: an image processing block configured to carry out a specific process based on input setting data; a plurality of control blocks configured to control the specific process of the image processing block independently; and a plurality of register sets configured to be used in data communication between each of the plurality of control blocks and the image processing block, wherein each of the remaining control blocks performs data communication with the image processing block using the corresponding register set when any one of the plurality of control blocks is controlling the specific process of the image processing block.

According to a second aspect of the invention, there is provided an image processing apparatus comprising: an image processing apparatus comprising: a plurality of control blocks; an image processing block configured to be accessible equally by the plurality of control blocks, wherein any one of the plurality of control blocks not only accesses the image processing block without intervention of a bus line but also issues a start trigger signal to the image processing block when accessing the image processing block, the image processing block not only carries out a specific process in response to the start trigger signal but also issues an interrupt signal to the control block that issued the start trigger signal at the end of the specific process, and exclusive control of the image processing block is performed based on the start trigger signal and the interrupt signal.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a configuration of an image processing apparatus according to an embodiment of the invention;

FIG. 2 is a diagram to explain a distortion correction process for each block according to the embodiment;

FIG. 3 is a timing chart to explain an operation of the image processing apparatus according to the embodiment;

FIG. 4 is a flowchart to explain a way a CPU controls a distortion correction process in the embodiment;

FIG. 5 is a flowchart to explain a way a sequencer controls a distortion correction process in the embodiment; and

FIG. 6 is a diagram showing a configuration of a modification of the embodiment when a distortion correction range computing unit holds a start trigger signal.

### DETAILED DESCRIPTION OF THE INVENTION

Hereinafter, referring to the accompanying drawings, an embodiment of the invention will be explained.

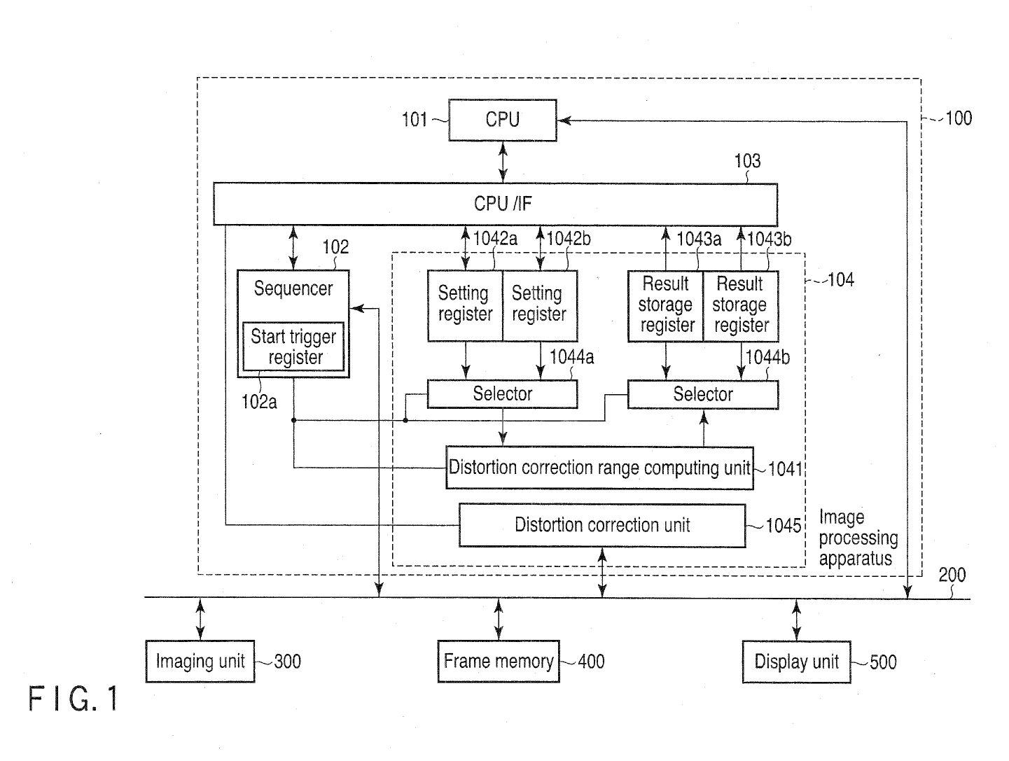

FIG. 1 is a diagram showing a configuration of an image processing system which includes an image processing apparatus according to an embodiment of the invention. The image processing system of FIG. 1 comprises an image processing apparatus 100, a bus line 200, an imaging unit 300, a frame memory 400, and a display unit 500.

The image processing apparatus 100 divides one frame of image data stored in the frame memory 300 into a plurality of blocks and performs specific image processing on each of the divided blocks. The configuration of the image processing apparatus 100 of FIG. 1 is such that the image processing apparatus of the embodiment is applied to a distortion correction apparatus for correcting a distortion in the image data stored in the frame memory 300. The configuration of the image processing apparatus 100 is described later in detail.

The bus line 200 is a transfer path for transferring various types of digital data, including data generated at the image processing apparatus 100 and the image data stored in the frame memory 300. The image processing apparatus 100, imaging unit 300, frame memory 400, and display unit 500 are connected to the bus line 200. The image processing apparatus 100, imaging unit 300, frame memory 400, and display unit 500 are configured to enable data communication via the bus line 200.

The imaging unit 300 obtains image data by imaging a subject. The frame memory 400 stores various types of digital data, including image data obtained by the imaging unit 300. The display unit 500 displays an image based on the image data stored in the frame memory 400 as a result of image processing at the image processing apparatus 100.

Next, the image processing apparatus 100 will be explained in detail. The image processing apparatus 100 of FIG. 1 comprises a CPU 101, a sequencer 101, a CPU interface 103, and an image processing unit 104.

The CPU 101 functioning as a control block supervises the overall operation of the image processing system, including control of a distortion correction process for each of the blocks divided at the image processing unit 104, control of the operation of the imaging unit 300, and control of the operation of display unit 500. The sequencer 102 functioning as a control block differing from the CPU 101 controls the distortion correction process for each of the blocks divided at the image processing module 104 without the intervention of the bus line 200, while monitoring the operating cycle of the CPU 101.

In the embodiment, the CPU 101 and sequencer 102 set a setting register in the image processing unit 104 when a distortion correction process is started block by block. In addition, the CPU 101 and sequencer 102 issue a start trigger signal after having set the setting register, thereby controlling a distortion correction range computing unit in the image processing module 104. Furthermore, after the distortion correction range computing unit has calculated a distortion correction range, the CPU 101 and sequencer 102 refer to a register value held in a result storage register and input the register value to the distortion correction unit of the image processing module 104, thereby starting a distortion correction process.

The sequencer 102 of the embodiment includes a start trigger register 102a acting as a holding block. The start trigger register 102a is a register for holding a start trigger signal issued by the CPU 101.

The CPU interface 103 functions as an interface for enabling the CPU 101 to communicate with the sequencer 102 and image processing unit 104. The CPU interface 103 also functions as an interface for enabling the sequencer 102 to communicate with the CPU 101 and image processing unit 104.

The image processing unit 104 performs a distortion correction process on image data read from the frame memory 400 via the bus line 200 under the control of the CPU 101 or sequencer 102. The image processing unit 104 includes a distortion correction range computing unit 1041, setting registers 1042a, 1042b, result storage registers 1043a, 1043b, selectors 1044a, 1044b, and a distortion correction unit 1045.

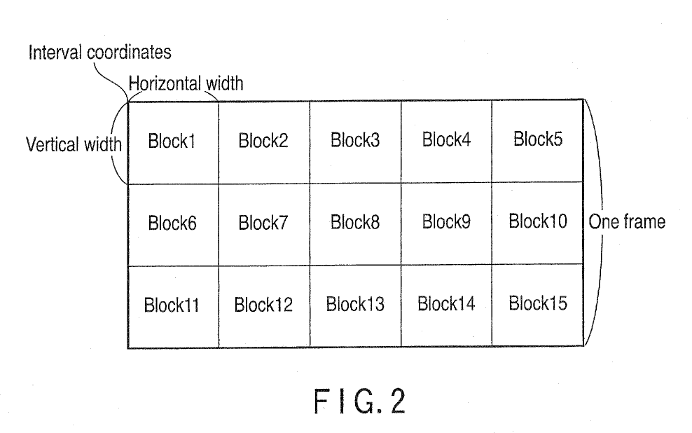

The distortion correction range computing unit 1041 functioning as an image processing block calculates a distortion correction range for each block according to setting data set in setting register 1042a or setting register 1042b. Generally, in a distortion correction process for each block, a rectangular block as shown in FIG. 2 obtained after the distortion correction is set and an input range of image data in which the distortion correction result of the rectangular block can be obtained is calculated as a distortion correction range. Since there is a correspondence relationship between the coordinates of each block after distortion correction and the coordinates of each block before distortion correction, if setting data indicating the range of each block after distortion correction is set in advance, a distortion correction range corresponding to the range of the block can be calculated. Setting data for setting the range of a rectangular block after distortion correction includes the start coordinates, vertical width, and horizontal width of a block and is set by the CPU 101 or sequencer 102.

In the embodiment, the CPU 101 sets setting data corresponding to a block to be processed first in one frame of image data (e.g., block 1, a block at the top left) and the sequencer 102 sets setting data corresponding to the remaining blocks. With this configuration, the CPU 101 need not control the distortion correction processes performed on all the blocks. Accordingly, the load on the CPU 101 can be decreased.

Setting register 1042a and result storage register 1043a are a register set for enabling the CPU 101 to communicate with the distortion correction range computing unit 1041. Setting register 1042a holds setting data set by the CPU 101. Result storage register 1043a holds the result of calculating a distortion correction range based on the setting data set by the CPU 101 (i.e., distortion correction range data).

Setting register 1042b and result storage register 1043b are a register set for enabling the sequencer 102 to communicate with the distortion correction range computing unit 1041. Setting register 1042b holds setting data set by the sequencer 102. Result storage register 1043b holds the result of calculating a distortion correction range based on the setting data set by the sequencer 102 (i.e., distortion correction range data).

As described above, in the embodiment, setting register 1042a and result storage register 1043a are used exclusively by the CPU 101. Setting register 1042b and result storage register 1043b are used exclusively by the sequencer 102. With this configuration, setting data set by one of the CPU 101 and sequencer 102 will not be overwritten when the other sets setting data. Result data held under the control of the distortion correction computing unit 1041 of one of the CPU 101 and sequencer 102 will not be overwritten when the distortion correction computing unit 1041 of the other performs control.

According to the start trigger signal input from the sequencer 102, selector 1044a selects either setting register 1042a or setting register 1042b. According to the start trigger signal input from the sequencer 102, selector 1044b selects either result storage register 1043a or result storage register 1043b.

In the embodiment, the start trigger signal issued by the CPU 101 differs from the start trigger signal issued from the sequencer 102 in logic level. Selector 1044a and selector 1044b can identify a start trigger signal. If the input start trigger signal has been issued by the CPU 101, selector 1044a selects setting register 1042a. If the input start trigger signal has been issued by the sequencer 102, selector 1044a selects setting register 1042b. If the input start trigger signal has been issued by the CPU 101, selector 1044b selects result storage register 1043a. If the input start trigger signal has been issued by the sequencer 102, selector 1044b selects result storage register 1043b.

The distortion correction unit 1045 reads image data in a range according to a value (a distortion correction range) in result storage register 1043a referred to by the CPU 101 or a value (a distortion correction range) in result storage register 1043b referred to by the sequencer 102 from the frame memory 400 via the bus line 200 and carries out a distortion correction process.

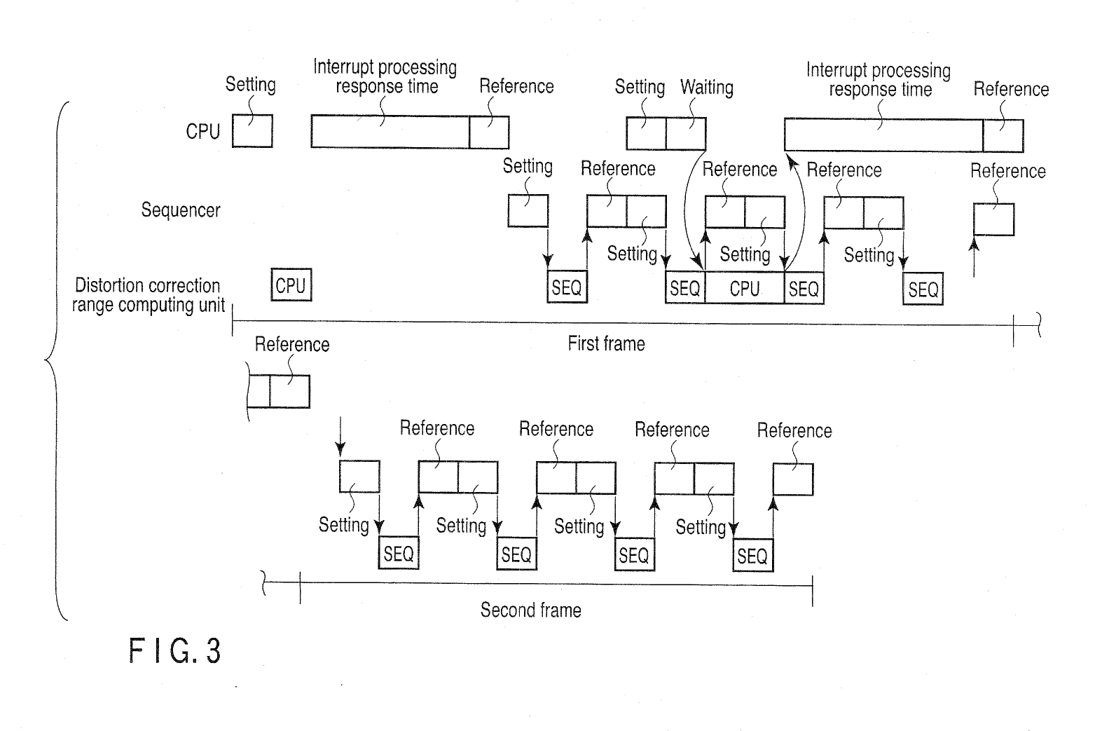

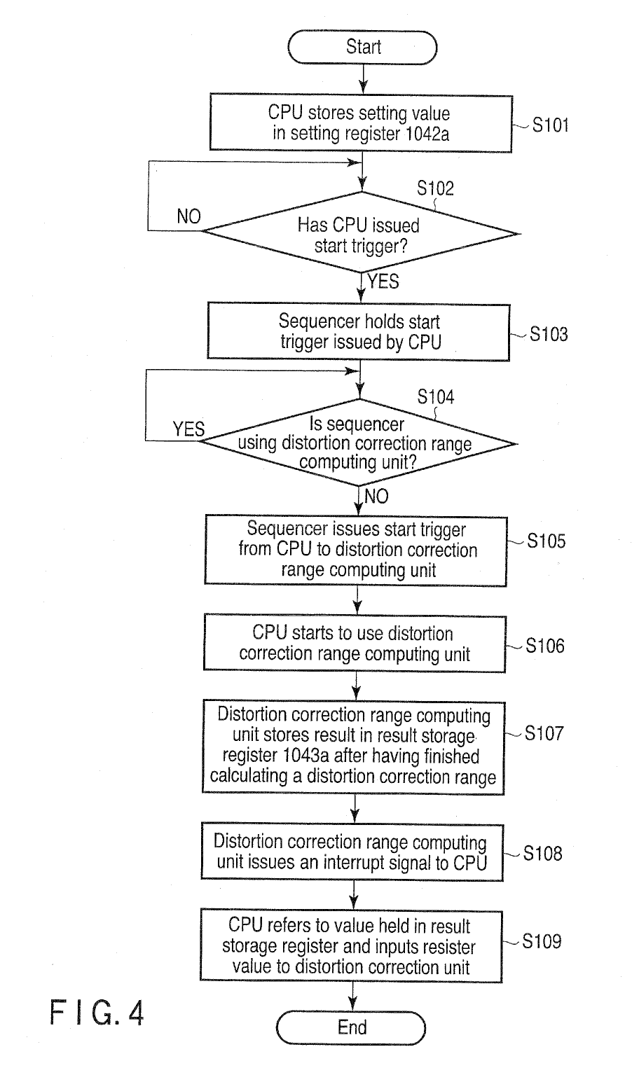

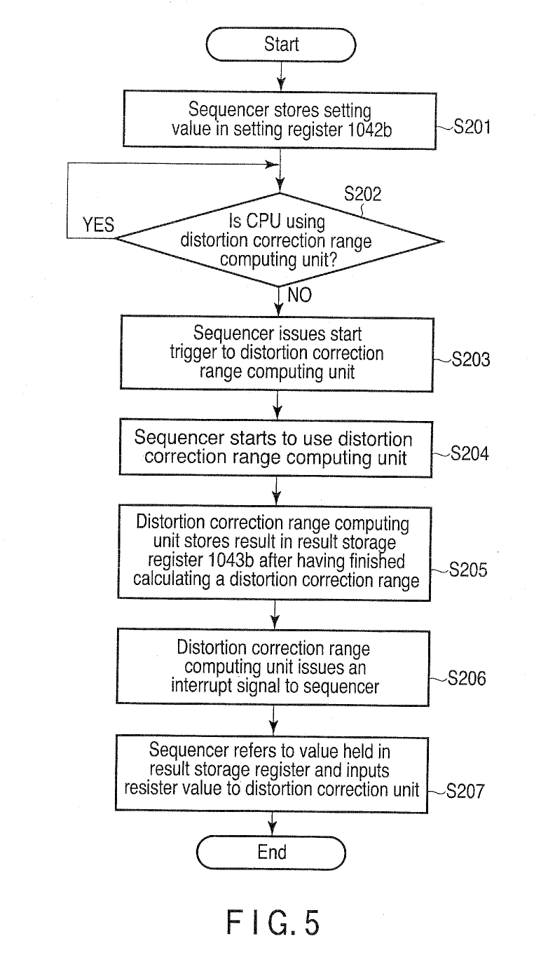

Next, the operation of the image processing apparatus 100 of FIG. 1 will be explained in detail. FIG. 3 is a timing chart to explain the operation of the image processing apparatus 100 in the embodiment. FIGS. 4 and 5 are flowcharts to explain the operation of the image processing apparatus 100 in the embodiment. FIG. 3 shows the process of correcting a distortion in 2 frames of image data obtained by, for example, movie shooting or continuous shooting.

As described above, a distortion correction process for block 1, the first block in each frame, is controlled by the CPU 101. In this case, control shown in FIG. 4 is performed. At this time, the CPU 101 sets setting data representing the range of block 1 in setting register 1042a via the CPU interface 103 (step S101). Thereafter, the CPU 101 issues a start trigger signal via the CPU interface 103 to cause the distortion correction range computing unit 1041 to operate.

The sequencer 102 determines whether the CPU 101 has issued a start trigger signal (step S102). The sequencer 102 waits until the CPU 101 issues a start trigger signal. In step S102, when the CPU 101 has issued a start trigger signal, the sequencer 102 stores the start trigger signal issued by the CPU 101 in the start trigger register 102a via the CPU interface 103 (step S103). Thereafter, the sequencer 102 determines whether the sequencer 102 itself is using the distortion correction range computing unit 1041, or controlling the distortion correction range computing unit 1041 (step S104). If it has been determined in step S104 that the sequencer 102 itself is using the distortion correction range computing unit 1041, the sequencer 102 waits, while making a determination in step S104. If it has been determined in step S104 that the sequencer 102 itself is not using the distortion correction range computing unit 1041, the sequencer 102 outputs the start trigger signal held in the start trigger register 102a (step S105). In response to the start trigger signal, the distortion correction range computing unit 1041 reads the setting data set in the setting register 1042a via selector 1044a and computes a distortion correction range corresponding to block 1 using the read setting data. As shown in FIG. 3, during the period, the CPU 101 is using the distortion correction range computing unit 1041, or controlling the distortion correction range computing unit 1041 (step S106).

After having calculated a distortion correction range, the distortion correction range computing unit 1041 stores the distortion correction range calculation result into result storage register 1043a via selector 1044b (step S107). After having stored the calculation result, the distortion correction range computing unit 1041 issues an interrupt signal to the CPU 101 via the CPU interface 103 (step S108). In response to the interrupt signal, the CPU 101 refers to the calculation result stored in result storage register 1043a via the CPU interface 103 and inputs the calculation result to the distortion correction unit 1045 via the CPU interface 103 (step S109). In response to the input of the calculation result, the distortion correction unit 1045 carries out a distortion correction process on block 1. After having input the calculation result to the distortion correction unit 1045, the CPU 101 issues a start trigger signal to the sequencer 102 to cause the sequencer 102 to operate. In response to the start trigger signal, the sequencer 102 reads the sequence code stored in the frame memory 400 via the bus line 200 and carries out a distortion correction process on block 2 and subsequent ones. In this case, control shown in FIG. 5 is performed.

At the time when the distortion correction range computing unit 1041 issues an interrupt signal, the CPU 101 might be controlling another block whose priority is higher than that of the image processing apparatus 100. In such a case, after an interrupt processing response time, the time required to complete control of another block with a higher priority, has passed, the calculation result stored in result storage register 1043a is referred to.

In FIG. 5, the sequencer 102 sets setting data indicating the range of a block to be presently processed in setting register 1042b via the CPU interface 103 (step S201). Thereafter, the sequencer 102 determines whether the CPU 101 is using the distortion correction range computing unit 1041, or controlling the distortion correction range computing unit 1041 (step S202). If it has been determined in step S202 that the CPU 101 is using the distortion correction range computing unit 1041, the sequencer 102 waits, while making a determination in step S202. If it has been determined in step S202 that the CPU 101 is not using the distortion correction range computing unit 1041, the sequencer 102 outputs a start trigger signal (step S203). Having received the start trigger signal, the distortion correction range computing unit 1041 reads the setting data set in setting register 1042b via selector 1044a and calculates a distortion correction range corresponding to a block to be presently processed. As shown in FIG. 3, during the period, the sequencer 102 is using the distortion correction range computing unit 1041 (SEQ in FIG. 3) (step S204).

After having calculated a distortion correction range, the distortion correction range computing unit 1041 stores the distortion correction range calculation result in result storage register 1043b via selector 1044b (step S205). After having stored the calculation result, the distortion correction range computing unit 1041 issues an interrupt signal to the sequencer 102 via the CPU interface 103 (step S206). In response to the interrupt signal, the sequencer 102 refers to the calculation result stored in result storage register 1043b via the CPU interface 103 and inputs the calculation result to the distortion correction unit 1045 via the CPU interface 103 (step S207). As a result, the distortion correction unit 1045 carries out a distortion correction process. The operations in step S201 to step S207 are repeated until the processing of one frame of image data in a block has been completed.

As described above, in the embodiment, a setting register and a result storage register are provided for each of the CPU and the sequencer. Accordingly, even in a period excluding a distortion correction process of block 1, the CPU 101 can use the distortion correction range computing unit 1041 in a period when the sequencer 102 is not controlling the distortion correction range computing unit 1041. Therefore, as shown in FIG. 3, during the period when the sequencer 102 is controlling the distortion correction range computing unit 1041, the CPU 101 sets setting register 1042a. Thereafter, during the period when the sequencer 102 is not controlling the distortion correction range computing unit 1041, the CPU 101 calculates a distortion correction range corresponding to block 1 of the next frame and stores the calculation result in result storage register 1043a. By doing this, the CPU 101 can carry out a distortion correction process on block 1 of the next frame by just referring to the value in result storage register 1043a. As described above, each of the CPU 101 and sequencer 102 accesses the distortion correction range computing unit 1041 exclusively, thereby enabling the image processing time to be shortened remarkably.

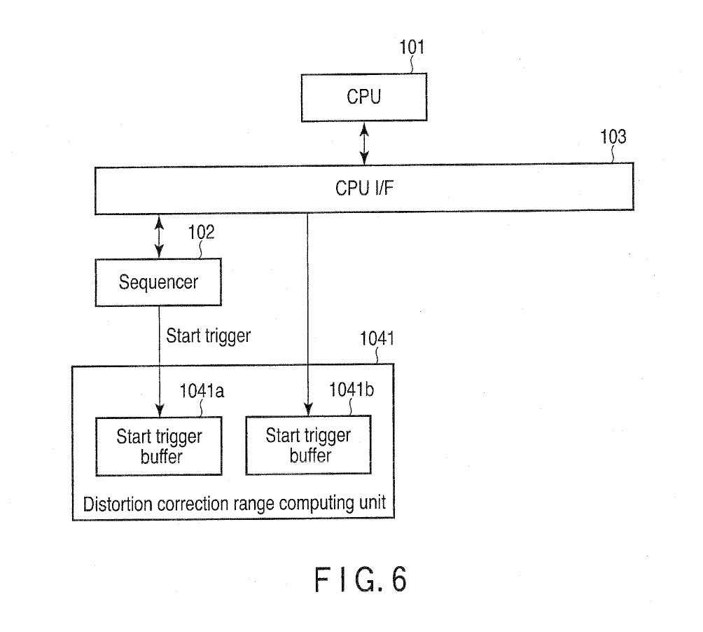

In the embodiment, to input the start trigger signal issued by each of the CPU 101 and sequencer 102 exclusively to the distortion correction range computing unit 1041, the start trigger signal issued by the CPU 101 is stored in the start trigger register 102a. Alternatively, for example, a configuration shown in FIG. 6 enables the distortion correction range computing unit 1041 to be accessed exclusively. FIG. 6 shows only the modifications to FIG. 1. The configuration of FIG. 6 is such that the distortion correction range computing unit 1041 is provided with a start trigger buffer 1041a functioning as a holding block for holding a start trigger signal issued by the CPU 101 and a start trigger buffer 1041b functioning as a holding block for holding a start trigger signal issued by the sequencer 102. In the configuration of FIG. 6, the distortion correction range computing unit 1041 calculates a distortion correction range using a setting register corresponding to either the start trigger buffer 1041a or the start trigger buffer 1041b which holds the start trigger signal earlier. Even when the configuration of FIG. 6 is used, the same effect as that of the embodiment is obtained.

In the embodiment, the distortion correction apparatus has been used as the image processing apparatus. However, the techniques of the embodiment may be applied not only to the distortion correction apparatus but also to various image processing apparatuses where a plurality of control blocks control a common image processing block.

Furthermore, in the embodiment, the CPU 101 and sequencer 102 have been used as control blocks. The techniques of the embodiment may be applied to various image processing apparatuses where a plurality of control blocks control a common image processing block, including an image processing apparatus where two CPUs control one image processing block. Moreover, the number of control blocks is not limited to two. For instance, in the case of an image processing apparatus where three control blocks control a common image processing block, three setting registers and three storage registers are provided. Even with this configuration, the image processing time can be shortened by causing the remaining control blocks to set the setting registers during the period when a certain control block is controlling an image processing block.

In the embodiment, the CPU 101 and sequencer 102 can communicate with the register set in the image processing unit 104 via the common bus line 200. In contrast, the CPU 101 may be connected directly to setting register 1042a and result storage register 1042a and the sequencer 102 may be connected directly to setting register 1042b and result storage register 1042b.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
an image processing block configured to carry out a specific process based on input setting data;
a plurality of control blocks configured to control the specific process of the image processing block independently; and
a plurality of register sets configured to be used in data communication between each of the plurality of control blocks and the image processing block,
wherein each of the remaining control blocks performs data communication with the image processing block using the corresponding register set when any one of the plurality of control blocks is controlling the specific process of the image processing block.

2. The image processing apparatus according to claim 1, wherein the plurality of register sets include a first register configured to hold the setting data for the specific process in the image processing block and a second register configured to hold result data obtained by the specific process of the image processing block.

3. The image processing apparatus according to claim 1, wherein the plurality of control blocks issue a start trigger signal to the image processing block when controlling the specific process of the image processing block,
the image processing block carries out the specific process in response to the start trigger signal issued by any one of the plurality of control blocks, and
the image processing apparatus further comprises a holding block configured to hold the start trigger signal issued from one other of the plurality of control blocks when the image processing block is carrying out the specific process in response to the start trigger signal issued by any one of the plurality of control blocks.

4. The image processing apparatus according to claim 3, wherein the holding block is provided in any one of the plurality of control blocks, and
the control block provided with the holding block, when issuing the start trigger signal to the image processing block, holds the start trigger signal issued by one other control block in the holding block and, when not issuing the start trigger signal to the image processing block, outputs to the image processing block the start trigger signal issued by one other control block held in the holding block.

5. The image processing apparatus according to claim 3, wherein the holding block is provided in the image processing block and, when carrying out the specific process in response to the start trigger signal issued by any one of the plurality of control blocks, holds the start trigger signal issued by one other control block in the holding block and, when not carrying out the specific process in response to the start trigger signal issued by any one of the plurality of control blocks, carries out the specific process in response to the start trigger signal issued by one other control block held in the holding block.

6. An image processing apparatus comprising:
a plurality of control blocks;
an image processing block configured to be accessible equally by the plurality of control blocks,
wherein any one of the plurality of control blocks not only accesses the image processing block without intervention of a bus line but also issues a start trigger signal to the image processing block when accessing the image processing block,
the image processing block not only carries out a specific process in response to the start trigger signal but also issues an interrupt signal to the control block that issued the start trigger signal at the end of the specific process, and
exclusive control of the image processing block is performed based on the start trigger signal and the interrupt signal.
